(19) United States
(12) Patent Application Publication
(10) Pub. No.: US 2024/0370862 A1
(43) Pub. Date: Nov. 7, 2024

(54) MUTUAL AUTHENTICATION OF PEER-TO-PEER PAYMENTS

(71) Applicant: Visa International Service Association, San Francisco, CA (US)

(72) Inventors: Edwin Tay Kai Cong, Singapore (SG); Jozua Heng Yi Jie, Singapore (SG); Aditi RUNGTA, Singapore (SG); Zhao Lutong, Singapore (SG); Calven Lim Way Zheng, Singapore (SG)

(73) Assignee: Visa International Service Association, San Francisco, CA (US)

(21) Appl. No.: 18/312,402

(22) Filed: May 4, 2023

(51) Int. Cl. G06Q 20/38; G06Q 20/10

(52) U.S. Cl. CPC G06Q 20/388; G06Q 20/108; G06Q 20/3827; G06Q 20/3829

(57) ABSTRACT

Disclosed herein are systems and methods for secure, mutual, peer-to-peer payments. In one aspect, an encrypted secure system for peer to peer payments, comprising an authentication server is disclosed to receive, a model hash key and an encrypted transaction, from an initiator account; store, the model hash key in an associated database; setting, by the authentication server, a validation time limit for storing the hash key; send, the encrypted transaction to a recipient account; receive by the authentication server a response from the recipient account, the response comprising a response hash key; and validate the response, by the authentication server, based on a match between the response hash key and the model hash key.

### TECHNICAL FIELD

The present technology pertains to systems and methods for securing peer to peer payments especially within push payment services, applications and web apps. The systems and methods included herein are designed to ensure that the right recipient of a transaction receives the funds, transaction, or transaction request. In particular, but not by way of limitation, the present technology provides systems and methods for mutual authentication of peer-to-peer payments.

### SUMMARY

In one aspect, the present disclosure provides a method for authentication of peer to peer payments, the method comprising receiving, by an authentication server, a transaction from an initiator user device via an initiator server, wherein the transaction comprises a challenge and an answer set by the initiator user device; sending, by the authentication server, the challenge to a recipient user device via a recipient server; receiving, by the authentication server, a response from the recipient user device via the recipient server, wherein the answer is received by the recipient user device via an out of-band channel; and determining, by the authentication server, validity of the response to the challenge to allow the transaction from the initiator user device via the initiator server, wherein the response must match the answer to be valid.

In various aspects, the method comprises receiving funds, by an escrow account associated with the authentication server, from a bank associated with the initiator server; and holding the funds in the escrow account pending at least one of the determining by the authentication server of the validity of the answer or a predetermined period of time.

In several aspects, the method further comprises releasing the funds to a bank account associated to the recipient server upon successful determination by the authentication server of the validity of the answer.

In numerous aspects, the method further comprises releasing the funds to a bank account associated to the initiator server upon determination by the authentication server of an invalidity of the answer.

In various aspects, the method comprises allowing, by the authentication server, the transaction initiated by the initiator user device via the initiator server based on a successful negotiation between the initiator user device and the recipient user device based on a successful validation of the answer.

In several aspects, the method further comprises notifying, by the authentication server, the initiator user device via the initiator server of a successful negotiation between the initiator user device and the recipient user device based on a successful validation of the answer.

In several aspects, the method further comprises canceling, by the authentication server, the transaction initiated by the initiator user device via the initiator server based on an unsuccessful negotiation between the initiator user device and the recipient user device based on a successful validation of the answer.

In several aspects, the method comprises receiving, by the authentication server, a new transaction from the initiator user device via the initiator server, wherein the new transaction comprises a new challenge and a new answer set by the initiator user device.

In several aspects, the at least one of the new challenge is identical to the challenge or the new answer is identical as the answer.

In several aspects, the method comprises canceling, by the authentication server, the transaction initiated by the initiator user device via the initiator server based on a failure to validate the answer by the authentication server within a specific period.

In one aspect, the present disclosure provides an encrypted secure system for peer to peer payments, comprising an authentication server to receive, a model hash key and an encrypted transaction, from an initiator account; store, the model hash key in an associated database; setting, by the authentication server, a validation time limit for storing the hash key; send, the encrypted transaction to a recipient account; receive by the authentication server a response from the recipient account, the response comprising a response hash key; and validate the response, by the authentication server, based on a match between the response hash key and the model hash key.

In various aspects, the system further comprises the authentication server to receive a request for a public key of the recipient account, from the initiator account and send the public key of the recipient account to the initiator account.

In various aspects, the system further comprises the authentication server to allow a transaction to be completed, based on a successful validation.

In various aspects, the system further comprises the authentication server to cancel the encrypted transaction based on a failed validation.

In various aspects, the system further comprises the authentication server to cancel the encrypted transaction due to an expiration of the validation time limit before a successful validation has occurred.

In several aspects, the system further comprises the authentication server to authorize an escrow account to release funds to the recipient account, upon a successful validation.

In several aspects, the system further comprises the authentication server to notify, at least one of the initiator account or the recipient account of a successful validation between the initiator account and the recipient account based on a successful validation of the response hash key.

In one aspect, the present disclosure provides a client device to initiate and conduct secure peer to peer payments, the client device comprising a processor and a memory storing instructions, the instructions executable by the processor to send, a request to an authentication server, for a public key of a recipient account or device; receive, the public key from the authentication server; encrypt, a transaction to generate an encrypted message, wherein the encrypted message comprises a challenge, the public key of the account or device, and transaction details; generate, a model hash key, the model hash key comprising a model answer to the challenge, an initiator user account identifier, and a recipient user account identifier; and transmit, the encrypted message, and the model hash key to an authentication server; and receive, a notification from the authentication server. wherein the notification can comprise at least one of a confirmation of a successful validation or a failed validation.

In several aspects, the instructions further comprise cause a transfer of funds from an initiator user financial account to an escrow account, wherein the escrow account is associated or in communication with the authentication server.

In several aspects, the transaction details can comprise any of an amount of funds to be sent, amount of funds requested, type of funds to be sent, type of funds requested, currency, bank account details, peer to peer platform account details, or a transaction type.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates an architecture of the system for securing peer-to-peer payment methods, according to at least one aspect of the present disclosure.

FIG. 2 illustrates an architecture of the system for securing peer-to-peer payment method utilizing an escrow system, according to at least one aspect of the present disclosure.

FIG. 3 illustrates a flow diagram of a method for securing peer-to-peer payment methods, according to at least one aspect of the present disclosure.

FIG. 4A illustrates a first portion of a diagram of how various parts of the system interact to provide a method for encrypted secure peer to peer payments, according to at least one aspect of the present disclosure.

FIG. 4B illustrates a second portion of a diagram of how various parts of the system interact to provide a method for encrypted secure peer to peer payments, according to at least one aspect of the present disclosure.

FIG. 5 presents a block diagram of a computer apparatus, according to at least aspect of the present disclosure.

FIG. 6 is a diagrammatic representation of an example system that includes a host machine within which a set of instructions to perform any one or more of the methodologies discussed herein may be executed.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

In traditional peer to peer payment platforms, or push to pay platforms, mistakes can be made in paying the wrong individual or service. It is very difficult to reverse or correct a payment on such platforms once the transaction has posted. Such payment platforms can include platforms like Zelle™, used by banks, Venmo™, Cash App™, Apple Pay™, other bank-based services and the like. Some of these payment platforms utilize digital wallets or accounts associated with, linked to, or exclusive to the platform itself, while others make use of universally accepted digital wallets. Users may make mistakes when sending payments, transactions or transaction requests by selecting the wrong individual for example, due to user error, or due to complexities with the underlying platform or complexities in the user name. It may also be difficult to link specific accounts of certain payment platforms with users with the individual outside the platform leading to the wrong person being sent funds, money or the transaction/transaction request.

Presented herein are solutions that provide systems and methods for securely facilitating payments to an intended recipient via any peer to peer payment or transaction platform, or push to pay service. The presented solutions provide this via a system architecture that includes security methods that prevent the unintended recipient from receiving or accessing a payment, payment transaction, or payment transaction request (these are collectively referred to herein as “transaction”). The proposed architecture will provide an initiator of a transaction, such as a sender of a payment or payment request, assurance and confirmation that the intended recipient received the transaction.

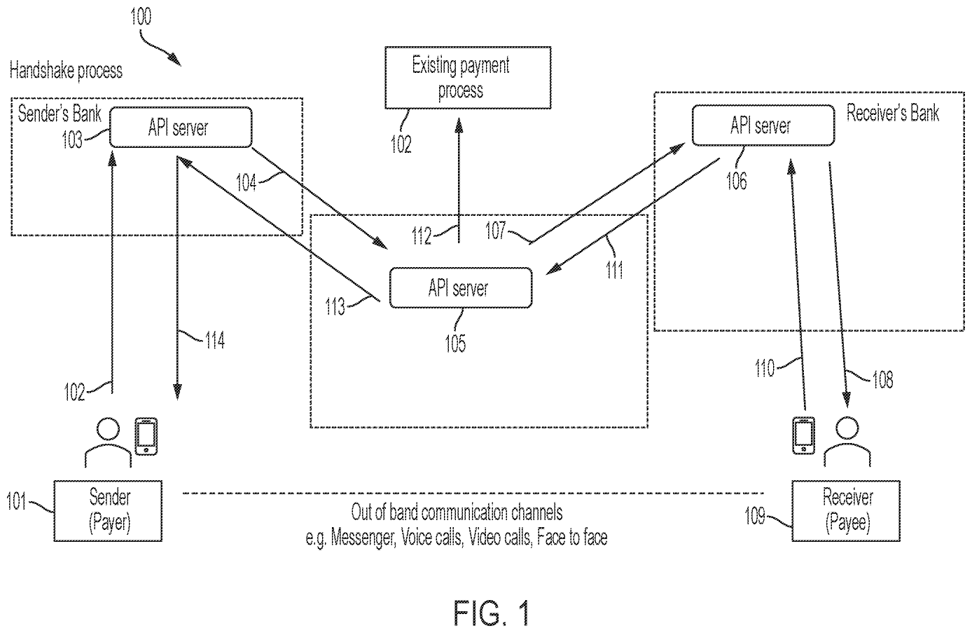

FIG. 1 illustrates an architecture of the system for securing peer-to-peer payment methods, according to at least one aspect of the present disclosure. This architecture comprises an initiator user device 101 (also referred to herein simply as “initiator device”) of an initiator user, i.e., a device of a user that is an initiator of a transaction 102 (this user is referred to herein as an “initiator”). In various aspects, the initiator user device 101 (or “initiator device”) sends the transaction 102 that includes a challenge or question (these are referred to interchangeably herein), and a model answer or model accepted response (referred to interchangeably herein) to the challenge, to an initiator server 103. The initiator server 103 can be an API sever, which could for example, belong to, or be associated with a financial institution such as a bank associated with the initiator device 101 or an account of the initiator user. In numerous aspects, the transaction 102 can be sent via a peer to peer payment platform or push to pay service. In several aspects, the initiator server 103 then transmits 104 the challenge and accepted response to an authentication server 105 that can be an API server acting as an intermediary between the initiator sever 103 and a recipient server 106. The authentication server 105 can forward, send, or transmit 107 the challenge and the accepted response to the recipient server 106. The recipient server 106 can each be API servers of an organization, bank, or financial institution associated with an intended recipient of the transaction. The recipient server 106 then receives the challenge from the authentication server 105 and pushes or transmits 108 it to a recipient user device 109 (also referred to herein as “recipient device”) of a recipient user (also referred to herein simply as “recipient”).

Once the recipient user device 109 receives the challenge from the recipient server 106. The user of the recipient user device 109 must provide a response 110 to the challenge received on the recipient device 109. The answer may already be known to the recipient and is merely input, or it may be received via a secondary or out-of-band-communication channel, such as an independent text message, communication application, or other electronic methods of communication, for example, email, or direct communication relayed by the initiator to the recipient in person.

Once the recipient server 106 receives the communicated answer or response from recipient device 109, it sends 111 or transmits the response to the authentication server 105, which then compares the response from the recipient server 106 to the model acceptable response provided by the initiator server 103. If the response from the recipient server 106 matches the model answer provided by the initiator server 103, then authentication server 105 determines that the answer is valid and validates 112 the answer to allow the transaction to proceed or to facilitate the transaction. Upon successful validation 112, the authentication server 105 notifies 113 the initiator server 103 of the successful validation 112 and of the facilitation and/or processing of the transaction. The initiator server 103 can then in turn push a notification to the initiator device 101 informing initiator user of the successful transaction. In various aspects, the authentication server 105, also notifies the recipient server 106 of successful validation or processing of the transaction which in turn can be relayed to the recipient device 109.

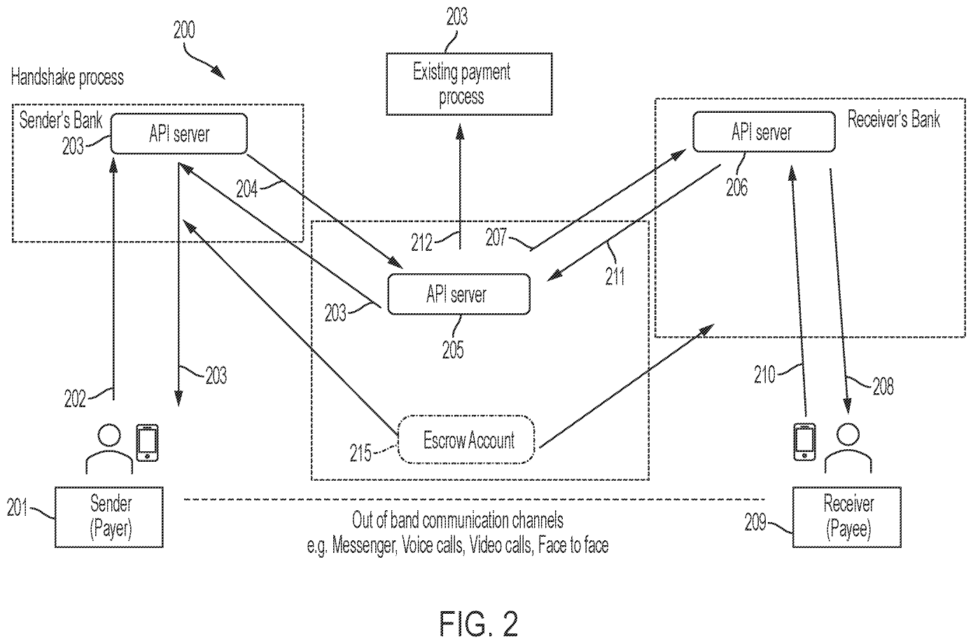

FIG. 2 illustrates an architecture 200 of the system for securing peer-to-peer payment method utilizing an escrow system, according to at least one aspect of the present disclosure. This architecture comprises an initiator user device 201) of an initiator user, or initiator of a transaction, also referred to herein as “initiator”). In various aspects, the initiator user device 201 sends or transmits 202 a transaction that includes a challenge or question, and a model answer/model acceptable response to the challenge, to an initiator server 203. The Initiator server 203 can be an API server that could include belong to or be associated with a bank or other financial institution associated with the initiator device 201 or to account(s) of the initiator user. In numerous aspects, transmission 202 is undertaken via a peer to peer payment platform, or push to pay service. In several aspects, the initiator server 203 then sends 204 the challenge and accepted response to an authentication server 205 that can include an API server acting as an intermediary between the initiator server 203 and a recipient server 206. Concurrently, the initiator server 203 can send 204 funds to an escrow account 215 to be released once the challenge from the initiator device 201 is validated by receiving a correct response/answer. The authentication server 205 can forward, send, or transmit 207 the challenge and the accepted response to the recipient server 206. The recipient server 206 can be an API server of a bank or financial institution associated with an intended recipient of the transaction and their account(s). The recipient server 206 then receives the challenge or question from the authentication server 205 and pushes it or transmits 208 it to a recipient user device 209 (also referred to herein as “recipient device”) of a recipient user.

Once the recipient user device 209 receives the challenge from the recipient server 206, the user of the recipient user device 209 must provide response to the challenge or question received, which is transmitted 210 to the recipient server 206. The answer may be known to the recipient and is therefore input by the recipient, or the answer may be received via a secondary or out-of-band-communication channel, such as a separate text message, a communication application, other electronic methods of communication, for example, email, or be directly physically communication to the recipient in person, by the initiator.

Once the recipient server receives the communicated answer or response from the recipient device 209, it sends 211 or transmits the response to the authentication server 205, which then compares the response from the recipient server 206 to the model accepted response provided by the initiator server 203. If the response from the recipient server 206 matches the model answer provided by the initiator server 203, then the authentication server 205 determines that the answer is valid and validates 212 the answer to allow the transaction to proceed or to facilitate the transaction. Upon successful validation 212, the authentication server 205 can authorize release of funds by the escrow account 215, whereupon escrow account releases 216 the funds to a bank account or financial institution associated with the recipient server 206, the recipient device 209 or account(s) of the recipient. The authentication server 205 can also notify 213 the initiator server 203 of successful validation 212 and the facilitation and/or transaction processing. The initiator server 203 can then in turn push a notification to the initiator device 201 informing the initiator user of the successful transaction. In various aspects, the authentication server 205, also notifies the recipient server 206 of successful validation or processing of the transaction which in turn can be relayed to the recipient device 209.

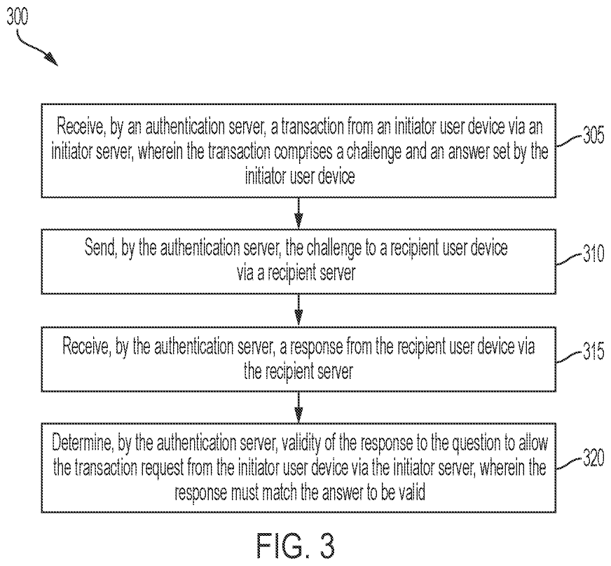

FIG. 3 illustrates a flow diagram of a method 300 for securing peer-to-peer payment methods, according to at least one aspect of the present disclosure. Referring primarily to FIG. 3, along with FIGS. 1 and 2, the method 300 includes receiving 305 by an authentication server, such as the authentication server 105, FIG. 1, a transaction from an initiator user device, e.g., the initiator device 101, FIG. 1, via an initiator server, e.g., the initiator server 103, FIG. 1, wherein the transaction comprises a challenge and an answer set by the initiator user device. The method 300 may continue with sending 310, by the authentication server, the challenge to a recipient user device, e.g., the recipient device 109, FIG. 1, via a recipient server, e.g., the recipient server 106, FIG. 1. The Method 300 can also include receiving 315 by the authentication server, a response from the recipient user device, e.g., the recipient device 109, FIG. 1, via the recipient server, e.g., the recipient server 106, FIG. 1. The method 300 can continue by determining 320, by the authentication server, a validity of the response to the question, to allow the transaction, from the initiator user device via the initiator server, wherein the response must match the answer to be valid.

In numerous aspects, based on the determined validity of the response, the authentication sever can either facilitate the transaction, if it can validate the response as matching an accepted/model answer or response, or alternatively, cancel the transaction, if it determines that the response received does not match the model accepted answer or response. In several aspects, the method 300 can include receiving funds, by an escrow account in communication with the authentication server, e.g. the escrow account 215, FIG. 2, from a bank associated with the initiator server (or in other aspect from the recipient sever, for example in a payment request transaction); and holding the funds in the escrow account pending at least one of the determining by the authentication server of the validity of the answer, or a predetermined period of time, and releasing the funds from the escrow account to a bank account associated to the recipient server (or in some aspects releasing fund to a bank account associated with the initiator server), upon successful determination by the authentication server of the validity of the answer provided by the recipient device, wherein the validity of the answer either matches or meets acceptable criteria or is within a pre-defined threshold (for example an accuracy threshold) of the answer provided by the initiator device.

In some aspects the method 300 comprises allowing, by the authentication server, the transaction initiated by the initiator user device via the initiator server, based on a successful negotiation between the initiator user device and the recipient user device, based on a successful validation of the answer. The method 300 may also comprise notifying, by the authentication server, the initiator user device via the initiator server of a successful negotiation between the initiator user device and the recipient user device based on a successful validation of the answer. In various aspects, the method 300 includes receiving, by the authentication server, a new transaction from the initiator user device via the initiator server, wherein the new transaction comprises a new challenge and a new answer set by the initiator user device. This could occur for example where one transaction is made up of multiple transactions, or when the initiator device sends another transaction following a first successful transaction. In some instances, a first transaction is undertaken automatically to test the reliability of the system, whereupon a second “real” transaction is undertaken subsequent to the successful validation of the first test transaction. Therefore in various aspects, at least one of the new challenge is the same as the challenge or the new answer is the same as the answer. In many aspects the method 300 can also include canceling, by the authentication server, the transaction initiated by the initiator user device via the initiator server based on a failure to validate the answer by the authentication server within a specific period. This can occur when the given response from the recipient device does not match or meet the requisite acceptable threshold of the answer to the challenge as provided by the initiator device.

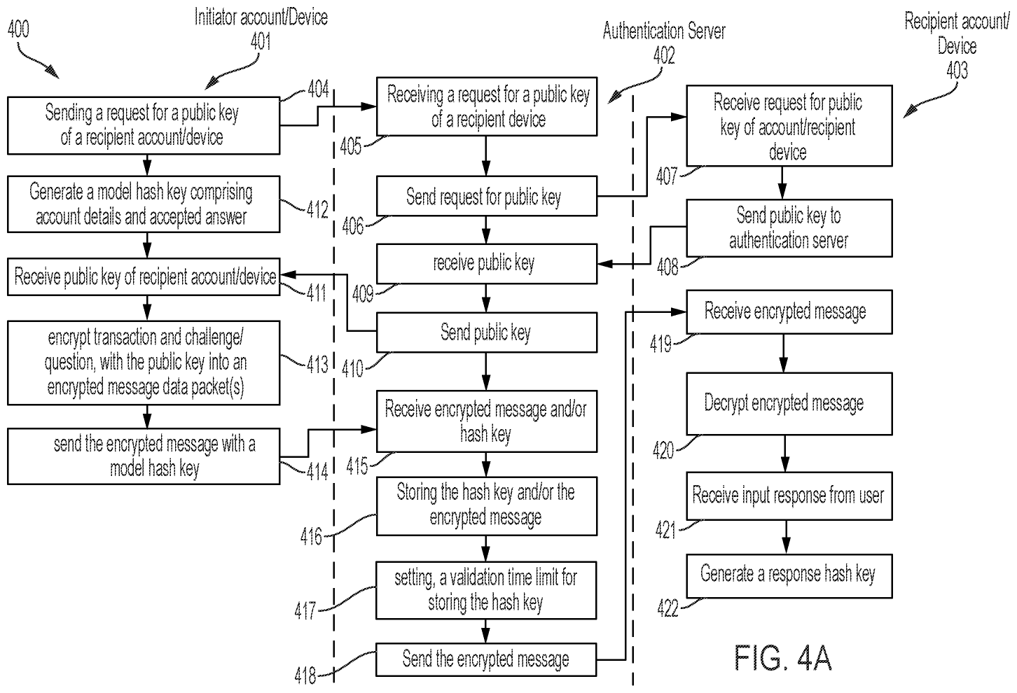

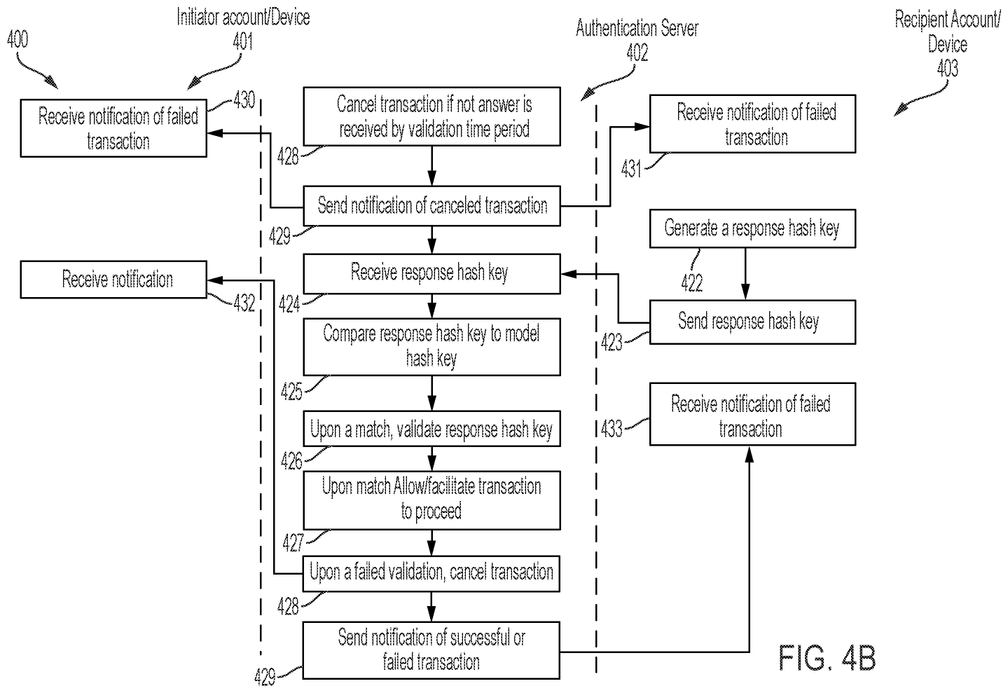

FIG. 4A-4B illustrates a diagram of how various parts of a system 400 interact to provide a method for encrypted secure peer to peer payments, according to at least one aspect of the present disclosure. Now referring primarily to FIG. 4A-4B alongside FIG. 1-2, the system 400 can include an initiator account/device 401, an authentication server 402, and a recipient account/device 403, these may correspond with the initiator device 101, 201, FIG. 1-2, and the authentication server 105, 205, FIG. 1-2, and the recipient device 109, 209, FIG. 1-2. Once a transaction is initiated by an initiator user, such as user of the initiator device/account 401, the system 400 can comprise sending 404 by the initiator device/account 401 a request to the authentication server 402, for a public key of a recipient account or of the recipient device 403. In several aspects a public/private key pair private is generated by the recipient user device 403 and is stored locally on the recipient device 403, the public key used to register with the authentication server 402, and thus can be provided by the authentication server 402 to the initiator device/account 401. In several aspects, the authentication server 402 may already possess the public key, while in some aspects the authentication server 402 must send 406 a request to the recipient device/account 403 for its public key based on receiving 405 a request for a public key of a recipient device. The recipient device/account 403 receives 407 the request and sends 408 the public key of the account/recipient device to authentication server 402. The authentication server 402 then receives 409 the public key and sends it 410 to the initiator account/device 403 which receives it 411. In several aspects, the initiator account/device 401 generates locally 412 a hash key comprising the account 401 of the initiator user, the account 403 of the recipient user and a model acceptable answer/response to a challenge/question (this hash key is referred to as the “model hash key” containing the model or acceptable answer or response).

The initiator account/device can then encrypt 413 with the public key it received at block 411, the transaction (and its accompanying transaction details), along with a challenge/question corresponding with the answer in the model hash key, and a copy of the public key into an encrypted message (also referred to herein as “encrypted transaction”). The initiator/account device 401 can then send 414 the generated model hash key along with the encrypted message (which can be comprised of one or more data packets) containing the transaction, public key and question/challenge to the authentication server 402. The generated model hash key can comprise the model accepted response/answer in addition to information of the initiator device/account 401 and information of the recipient account 403. This information may comprise identifiers of the accounts 401, and 403. The authentication server 402 stores 416 the hash key and/or the encrypted message, in various aspects, in a database or storage associated with the authentication server 402. The authentication server 402 may then set 417 a validation time limit for storing the hash key. Because the answer is part of the model hash key it is not exposed to the authentication server 402. In various aspects, if a correct answer or response is not received by the authentication server 402 within the validation time limit, then the authentication server 402 will cancel 428 the transaction, and send a notification 429 to initiator account/device 401 and/or recipient account/device 403 to inform them of the canceled or failed transaction, the notification is received 430 by initiator account/device 401, and received 431 by the recipient account/device 403.

The authentication server 402 then sends 418 the encrypted message to the recipient account/device 403 which receives 419 the encrypted message. The recipient account/device 403 then decrypts 420 the encrypted message to reveal the question/challenge to a user via the device 403. The decryption 420 of the encrypted message/transaction, by the recipient user account/device 403 can occur locally on the recipient device 403, and in several aspects, it can be undertaken by using the public key of the recipient account or device, generated by the recipient device 403, wherein the decrypting 420 reveals the challenge, and the transaction details.

The recipient device/account 403 then receives 421 an input response to the question/challenge from the recipient user. An input can be made via voice, through a user interface displayed on the recipient device 403 that for example may provide a section to input a response, via a payment platform, or any other method to input a response to the revealed question. Locally, the recipient device generates 422 a response hash key comprising the input answer/response (hash key response), the initiator account/device 401 information, as well as the recipient device/account 403 information.

Upon receiving 421 an input response, and generating 422 a response hash key, the recipient device/account 403 then sends 423 the hash key response to the authentication server 402. The authentication server 402 receives 424 the hash key response and compares 425 it to the model hash key it received at block 415 from the initiator device/account 401, if the hash key response matches the model hash key received from the initiator device/account 401, then the authentication server 402 validates 426 the response hash key and allows, authorizes or facilitates 427 the transaction to proceed, otherwise if the hash key response does not match the model hash key, the authentication server 402 cancels 428 the transaction. In various aspects, the authentication server 402 sends a notification 429 to the initiator device/account 401 and/or the recipient device/account 403 informing them of either a successful or failed validation, which in turn are received 432/433 by the initiator device/account 401, and the recipient device/account 403, respectively. In several aspects facilitates, authorizes, or allows 427 the transaction to proceed can include authorization of release of funds from an escrow account, where funds are help pending validation by the authorization server 402, as has been described in detail in FIG. 2.

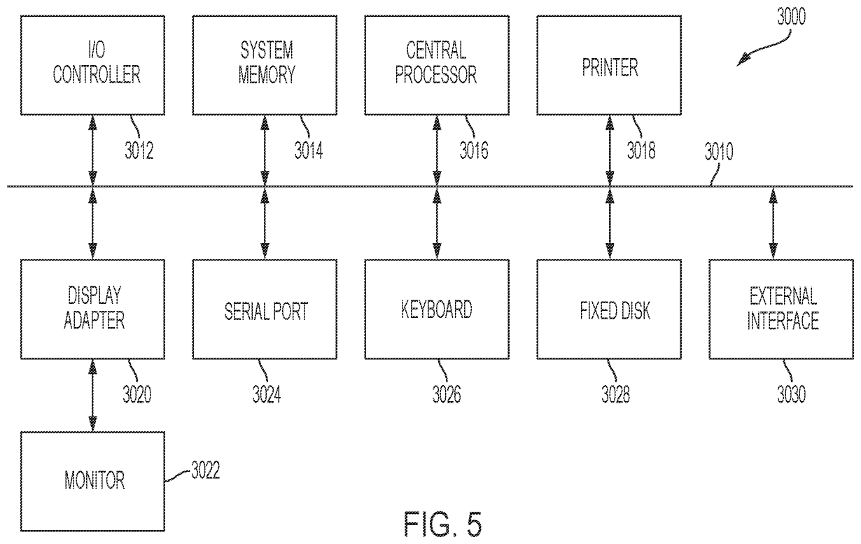

FIG. 5 is a block diagram of a computer apparatus 3000 with data processing subsystems or components, which a set of instructions to perform any one or more of the methodologies discussed herein may be executed, according to at least one aspect of the present disclosure. The subsystems shown in FIG. 5 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

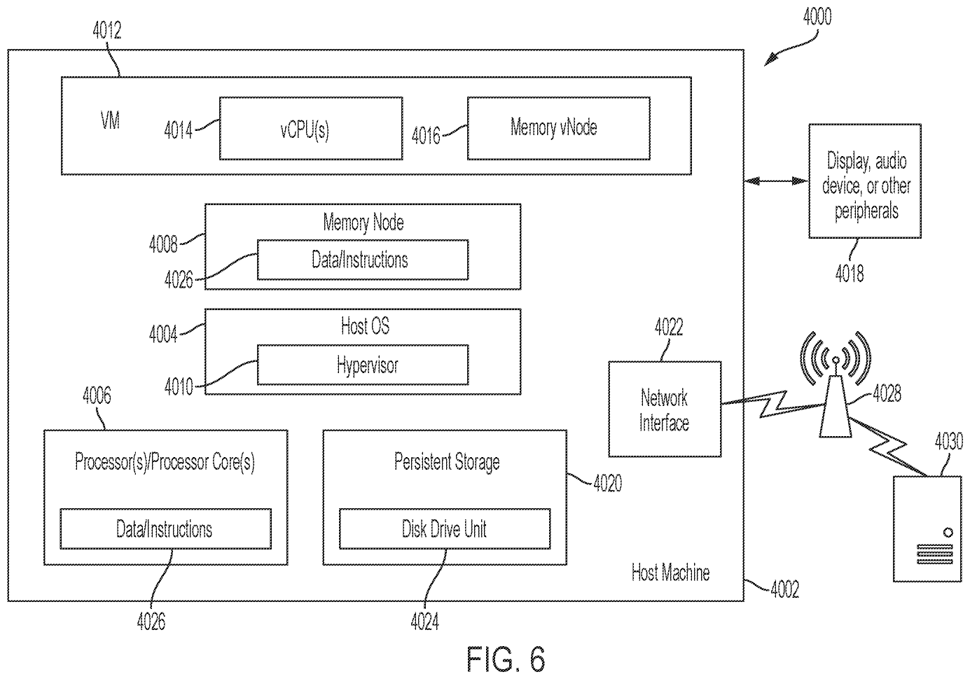

FIG. 6 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network comprising the server 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A method for authentication of peer to peer payments, the method comprising receiving, by an authentication server, a transaction from an initiator user device via an initiator server, wherein the transaction comprises a challenge and an answer set by the initiator user device; sending, by the authentication server, the challenge to a recipient user device via a recipient server; receiving, by the authentication server, a response from the recipient user device via the recipient server, wherein the answer is received by the recipient user device via an out of-band channel; and determining, by the authentication server, validity of the response to the challenge to allow the transaction from the initiator user device via the initiator server, wherein the response must match the answer to be valid.

Clause 2. The method of Clause 1 further comprising receiving funds, by an escrow account associated with the authentication server, from a bank associated with the initiator server; and holding the funds in the escrow account pending at least one of the determining by the authentication server of the validity of the answer or a predetermined period of time.

Clause 3. The method of any of Clauses1-2, further comprising releasing the funds to a bank account associated to the recipient server upon successful determination by the authentication server of the validity of the answer.

Clause 4. The method of any of Clauses 1-3, further comprising releasing the funds to a bank account associated to the initiator server upon determination by the authentication server of an invalidity of the answer.

Clause 5. The method of any of clauses 1-4, comprising allowing, by the authentication server, the transaction initiated by the initiator user device via the initiator server based on a successful negotiation between the initiator user device and the recipient user device based on a successful validation of the answer.

Clause 6. The method of any of clauses 1-5, comprising notifying, by the authentication server, the initiator user device via the initiator server of a successful negotiation between the initiator user device and the recipient user device based on a successful validation of the answer.

Clause 7. The method of any of clauses 1-6, comprising canceling, by the authentication server, the transaction initiated by the initiator user device via the initiator server based on an unsuccessful negotiation between the initiator user device and the recipient user device based on a successful validation of the answer.

Clause 8. The method of any of clauses 1-7, comprising receiving, by the authentication server, a new transaction from the initiator user device via the initiator server, wherein the new transaction comprises a new challenge and a new answer set by the initiator user device.

Clause 9. The method of any of clauses 1-8, wherein at least one of the new challenge is identical to the challenge or the new answer is identical as the answer.

Clause 10. The method of any of Clauses 1-9, further comprising: canceling, by the authentication server, the transaction initiated by the initiator user device via the initiator server based on a failure to validate the answer by the authentication server within a specific period.

Clause 11. An encrypted secure system for peer to peer payments, comprising an authentication server to receive, a model hash key and an encrypted transaction, from an initiator account; store, the model hash key in an associated database; setting, by the authentication server, a validation time limit for storing the hash key; send, the encrypted transaction to a recipient account; receive by the authentication server a response from the recipient account, the response comprising a response hash key; and validate the response, by the authentication server, based on a match between the response hash key and the model hash key.

Clause 12. The system of Clause 11 further comprising the authentication server to: receive a request for a public key of the recipient account, from the initiator account; and send the public key of the recipient account to the initiator account.

Clause 13. The system of any of Clauses11-12, further comprising the authentication server to allow a transaction to be completed, based on a successful validation.

Clause 14. The system of any of Clauses 11-14, further comprising the authentication server to cancel the encrypted transaction based on a failed validation.

Clause 15. The system of any of Clauses 11-15, further comprising the authentication server to cancel the encrypted transaction due to an expiration of the validation time limit before a successful validation has occurred.

Clause 16. The system of any of Clauses 11-16, further comprising the authentication server to authorize an escrow account to release funds to the recipient account, upon a successful validation.

Clause 17. The system of any of Clauses 11-17, further comprising the authentication server to notify, at least one of the initiator account or the recipient account of a successful validation between the initiator account and the recipient account based on a successful validation of the response hash key.

Clause 18. A client device to initiate and conduct secure peer to peer payments, the client device comprising a processor and a memory storing instructions, the instructions executable by the processor to send, a request to an authentication server, for a public key of a recipient account or device; receive, the public key from the authentication server; encrypt, a transaction to generate an encrypted message, wherein the encrypted message comprises a challenge, the public key of the account or device, and transaction details; generate, a model hash key, the model hash key comprising a model answer to the challenge, an initiator user account identifier, and a recipient user account identifier; and transmit, the encrypted message, and the model hash key to an authentication server; and receive, a notification from the authentication server, wherein the notification can comprise at least one of a confirmation of a successful validation or a failed validation.

Clause 19. The client device of Clause 18, wherein the instructions further comprise cause a transfer of funds from an initiator user financial account to an escrow account, wherein the escrow account is associated or in communication with the authentication server.

Clause 20 The client device of any of Clauses 18-19, wherein the transaction details can comprise any of an amount of funds to be sent, amount of funds requested, type of funds to be sent, type of funds requested, currency, bank account details, peer to peer platform account details, or a transaction type.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

Some descriptions of terms used in this document are provided below.

“Account credentials” may include any information that identifies an account and allows a payment processor to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

Further, the term “account credential,” “account number,” or “payment credential” may refer to any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may refer to one or more types of identifiers associated with an account (e.g., a unique identifier of an account, an account number, a PAN, a card number, a payment card number, a token, and/or the like) of a user. In some non-limiting embodiments or aspects, an issuer may provide an account identifier (e.g., a PAN, a token, a globally unique identifier (GUID), a universally unique identifier (UUID), and/or the like) to a user that uniquely identifies one or more accounts associated with that user. In some non-limiting embodiments or aspects, an account identifier may be embodied on a payment device (e.g., a portable financial instrument, a payment card, a credit card, a debit card, and/or the like) and/or may be electronic information communicated to the user that the user may use for electronic payment transactions. In some non-limiting embodiments or aspects, an account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments or aspects, an account identifier may be directly or indirectly associated with an issuer such that an account identifier may be a token that maps to a PAN or other type of identifier. Account identifiers may be alphanumeric, any combination of characters and/or symbols, and/or the like.

As used herein, the term “account token” may refer to an identifier that is used as a substitute or replacement identifier for an account identifier, such as a PAN. An account token may be used as a substitute or replacement identifier for an original account identifier, such as a PAN. Account tokens may be associated with a PAN or other original account identifier in one or more data structures (e.g., one or more databases and/or the like) such that they may be used to conduct a transaction without directly using the original account identifier. In some non-limiting embodiments or aspects, an original account identifier, such as a PAN, may be associated with a plurality of account tokens for different individuals or purposes. In some non-limiting embodiments aspects, account tokens may be associated with a PAN or other account identifiers in one or more data structures such that they can be used to conduct a transaction without directly using the account identifier, such as a PAN. In some examples, an account identifier, such as a PAN, may be associated with a plurality of account tokens for different uses or different purposes.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

As used herein, an “API” server can refer to hardware systems such as a computing device or a server, utilizing software such as an Application Programming Interface to allow it to utilize communication protocols with other hardware devices and other software programs, and allowing it to act as a middle-man or intermediary between a combination of hardware systems and various software modules run on them.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

“Authentication” is a process by which the credential of an endpoint (including but not limited to applications, people, devices, process, and systems) can be verified to ensure that the endpoint is who they are declared to be.

An “authorization platform” (e.g., an “issuer”) may be a system that can authorize a transaction.

An “authorization response message” may be an electronic message reply to an authorization request message generated by an issuing financial institution (e.g., issuer) or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may include an authorization code, which may be a code that an account issuing bank returns in response to an authorization request message in an electronic message (either directly or through the payment processing network) to the merchant's access device (e.g. POS terminal) that indicates approval of the transaction. The code may serve as proof of authorization. As noted above, in some embodiments or aspects, a payment processing network may generate and/or forward the authorization response message to the merchant.

As used herein, the terms “client” and “client device” may refer to one or more client-side devices or systems (e.g., remote from a transaction service provider) used to initiate or facilitate a transaction (e.g., a payment transaction). Moreover, a “client” may also refer to an entity (e.g., a merchant, an acquirer, and/or the like) that owns, utilizes, and/or operates a client device for initiating transactions (e.g., for initiating transactions with a transaction service provider).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

Throughout the specification, the term “complete payment credentials” should be broadly interpreted and may include any payment or financial account details that can be used to process a transaction. The first payment credential portion may be any part of the complete payment credentials while the second payment credential portion is the remaining part such that the first and second portions together form the complete payment credentials. In some embodiments or aspects, the first payment credential portion is transmitted “in the clear” during a transaction, while a shared key is used to transmit the second payment credential portion in an encrypted format.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes and other login information, etc.

A “cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

As used herein, an “electronic wallet,” “digital wallet” or “mobile wallet” can store user profile information, payment information (including tokens), bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device.

As used herein, the term “electronic wallet provider” may include an entity that provides and/or maintains an electronic wallet and/or an electronic wallet mobile application for a user (e.g., a customer). Examples of an electronic wallet provider include, but are not limited to, Google Wallet™, Android Pay®, Apple Pay®, and Samsung Pay®, and/or other like electronic payment systems. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “electronic wallet transaction processing system” may refer to one or more electronic devices and/or software applications configured to process and/or a request to authenticate a user for a transaction initiated and/or conducted by an electronic wallet application. For example, an electronic wallet transaction processing system may include server-side software and/or databases for maintaining and providing transaction data and/or account data to a merchant system and/or a payment gateway system for processing and/or authenticating a user for an electronic wallet transaction. An “electronic wallet transaction processing system provider” may include an entity that provides and/or maintains an electronic wallet transaction processing system, such as Visa Checkout, Mastercard MasterPass™, PayPal Checkout, and/or other like electronic wallet transaction processing system providers. In some non-limiting examples, a transaction service provider system may be an electronic wallet transaction processing system.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

A “key” may refer to a piece of information that is used in a cryptographic algorithm to transform input data into another representation. An exemplary encryption key may include a master derivation key (MDK) which may be used to generate a limited use key (LUK) that is provided to a computer device of a user. An LUK can be an encryption key that is intended for limited use (e.g., a limited number of transactions or a limited time period) and is not intended to be used for the lifetime of an account. Further details regarding LUKs can be found in U.S. Published Patent Application No. 2015/0180836, which is herein incorporated by reference in its entirety and is assigned to the same assignee as the present application. The MDK may be used to generate and provision the token, as well as, authenticate the token when used in authorization processing by validating static and variable transaction data.

A “key check value (KCV)” may refer to value obtained by passing a data value through a non-reversible algorithm. The key check value may be calculated using a cryptographic algorithm which takes as input a secret key and an arbitrary string, and which gives a cryptographic check value as output. The computation of a correct check value without knowledge of the secret key is not feasible.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “merchant category code” (MCC) may refer to a numerical indication of a type of business classified according to the goods or services the business provides, such as “supermarket,” “quick service restaurant,” or “fuel dispenser.” Different rates may be charged by a payment processing network depending on the MCC generating the transaction. A user may generate transactions having different associated MCC values and may wish to generate different routing priority lists for each MCC. A merchant verification value (MVV) may be a customizable value, such as a numerical indication of a region or a particular store.

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—e.g., using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

As used herein, the term “multimedia object” may refer to a digital file containing multimedia content including audio, images, animations, video, vibration patterns, and interactive content. Multimedia objects may be represented in various formats and computer file types or may be represented by a pointer, network address, or uniform resource indicator (URI) denoting a location at which a multimedia file may be located and/or retrieved. Multimedia objects may be output by a computing device with suitable output capability and may be observable by a device user or other entity.

As used herein, a “payment account” (which may be associated with one or more payment devices) may refer to any suitable payment account including a credit card account, a checking account, or a prepaid account.

A “payment application” or “wallet application” may store credentials (e.g., account identifier, expiration date, card verification value (CVV), etc.) for accounts provisioned onto the user device. The account credentials may be stored in general memory on the mobile device or on a secure trusted execution environment (e.g., a secure element) of the user device. Further, in some embodiments or aspects, the account credentials may be stored by a remote computer and the payment/wallet application may retrieve the credentials (or a portion thereof) from the remote computer before/during a transaction. Any number of different commands or communication protocols may be used to interface with the payment application and/or wallet application in order to obtain and use stored credentials associated with each application.

The payment application or wallet application may be configured to provide credentials to an authorized software application or module on a user device. For example, a payment application may be configured to interface with a master applet in order to provide credentials to a mobile application for a transaction. For instance, the payment application may provide a software development kit (SDK) or application programming interface (API) that the master wallet applet may use to interface with the payment application and/or wallet application. The payment application and/or wallet application may be configured to provide the sensitive information in encrypted form using stored encryption keys. Thus, each payment application and/or wallet application may have different commands and/or instructions for accessing the associated credentials stored by the payment/wallet application. For instance, each payment application and/or wallet application may have a different application program interface (API) with different commands, data requirements, authentication processes, etc., for interacting with other applications operating on the user device. Accordingly, a master wallet applet may include a number of different APIs, one for each of the different payment applications and/or wallet applications that the master wallet applet is configured to interface with.

A “payment device” may refer to any device that may be used to conduct a financial transaction, such as to provide payment information to a merchant. A payment device may be in any suitable form. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. For example, suitable payment devices can be hand-held and compact so that they can fit into a consumer's wallet and/or pocket (e.g., pocket-sized). They may include smart cards, debit devices (e.g., a debit card), credit devices (e.g., a credit card), stored value devices (e.g., a stored value card or “prepaid” card), magnetic stripe cards, keychain devices (such as the Speedpass™ commercially available from Exxon-Mobil Corp.), etc. Other examples of payment devices include cellular or wireless telephones (e.g., a smartphone), personal digital assistants (PDAs), portable computer (e.g. tablet or laptop computer), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. In some non-limiting embodiments or aspects, a payment device may include an electronic payment device, such as a smartcard, a chip card, integrated circuit card, and/or the like. An electronic payment device may include an embedded integrated circuit and the embedded integrated circuit may include a data storage medium (e.g., volatile and/or non-volatile memory) to store information associated with the payment device, such as an account identifier, a name of the account holder, and/or the like. The payment device may interface with an access device such as a point of sale device to initiate the transaction. In some embodiments or aspects, a mobile device can function as a payment device (e.g., a mobile device can store and be able to transmit payment credentials for a transaction). Further, a payment device may be associated with a value such as a monetary value, a discount, or store credit, and a payment device may be associated with an entity such as a bank, a merchant, a payment processing network, or a person. A payment device may be used to make a payment transaction.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

The terms “point-of-sale system,” “POS system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

According to various embodiments or aspects, a token may be associated with a token status. The token status may indicate, for example, that the token is a high quality token or a low quality token. The status of the token may be indicative of a level of restriction associated with the token. For example, no restrictions may be imposed on a high quality token whereas restrictions such as further identification requirements may be imposed on a low quality token. The status of the token may be based at least in part on the confidence level with which the token is generated.

In some embodiments or aspects, the token format may allow entities in the payment system to identify the issuer associated with the token. For example, the format of the token may include a token issuer identifier that allows an entity (e.g. the payment processing network) to identify an issuer of the token. For instance, the token issuer identifier may be associated with an issuer's BIN of the underlying PAN in order to support the existing payment flow. The token issuer identifier may be a different number than the issuer's BIN and may be static. For example, if the issuer's BIN for an issuer is 412345, the token issuer identifier may be a token BIN of 428325 and this number may be static for all tokens issued from or for that issuer. In some embodiments or aspects, the token issuer identifier range (e.g., issuer token BIN range) may have the same attributes as the associated issuer card range and can be included in an issuer identifier routing table (e.g., BIN routing table). The issuer identifier routing table may be provided to the relevant entities in the payment system (e.g., merchants and acquirers).

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

The term “transaction data” or “transaction request data” may include any data associated with one or more transactions or transaction requests. In some embodiments or aspects, the transaction data may merely include an account identifier (e.g., a PAN) or payment token. Alternatively, in other embodiments or aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

As used herein, the term “transaction” can include a “transaction request” or a request for a transaction or one part of a transaction, such as initiation of a transaction, a “transaction” also includes a payment, or a payment request, receiving a payment, making a payment, a bill, an invoice, a split-bill, or any other transaction involved in the transfer of funds or financial assets from one individual, device, or financial account, to another individual, device or financial account. A “transaction request” for example may include a request to split a bill or split-bill request, a direct request for payment from one or more users or recipients of the request, a sending of an invoice or a bill, or any other request for a transaction involved in the transfer of funds or financial assets from one individual, device, or financial account, to another individual, device or financial account.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction processing system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some embodiments or aspects, the device identifier may include a device fingerprint. The device fingerprint may an aggregation of device attributes. The device fingerprint may be generated by a software development kit (SDK) provided on the user device using, for example, a unique identifier assigned by the operating system, an International Mobile Station Equipment Identity (IMEI) number, operating system (OS) version, plug-in version, and the like.

What is claimed is:

1. A method for authentication of peer to peer payments, the method comprising:
receiving, by an authentication server, a transaction from an initiator user device via an initiator server, wherein the transaction comprises a challenge and an answer set by the initiator user device;
sending, by the authentication server, the challenge to a recipient user device via a recipient server;
receiving, by the authentication server, a response from the recipient user device via the recipient server, wherein the answer is received by the recipient user device via an out of-band channel; and
determining, by the authentication server, validity of the response to the challenge to allow the transaction from the initiator user device via the initiator server, wherein the response must match the answer to be valid.

2. The method of claim 1 further comprising:
receiving funds, by an escrow account associated with the authentication server. from a bank associated with the initiator server; and
holding the funds in the escrow account pending at least one of the determining by the authentication server of the validity of the answer or a predetermined period of time.

3. The method of claim 2, further comprising:
releasing the funds to a bank account associated to the recipient server upon successful determination by the authentication server of the validity of the answer.

4. The method of claim 2, further comprising:
releasing the funds to a bank account associated to the initiator server upon determination by the authentication server of an invalidity of the answer.

5. The method of claim 1, comprising allowing, by the authentication server, the transaction initiated by the initiator user device via the initiator server based on a successful negotiation between the initiator user device and the recipient user device based on a successful validation of the answer.

6. The method of claim 2, comprising notifying, by the authentication server, the initiator user device via the initiator server of a successful negotiation between the initiator user device and the recipient user device based on a successful validation of the answer.

7. The method of claim 1, comprising canceling, by the authentication server, the transaction initiated by the initiator user device via the initiator server based on an unsuccessful negotiation between the initiator user device and the recipient user device based on a successful validation of the answer.

8. The method of claim 4, comprising receiving, by the authentication server, a new transaction from the initiator user device via the initiator server, wherein the new transaction comprises a new challenge and a new answer set by the initiator user device.

9. The method of claim 8, wherein at least one of the new challenge is identical to the challenge or the new answer is identical as the answer.

10. The method of claim 1, further comprising: canceling, by the authentication server, the transaction initiated by the initiator user device via the initiator server based on a failure to validate the answer by the authentication server within a specific period.

11. An encrypted secure system for peer to peer payments, comprising an authentication server to:
receive, a model hash key and an encrypted transaction, from an initiator account;
store, the model hash key in an associated database;
setting, by the authentication server, a validation time limit for storing the hash key;
send, the encrypted transaction to a recipient account;
receive by the authentication server a response from the recipient account, the response comprising a response hash key; and
validate the response, by the authentication server, based on a match between the response hash key and the model hash key.

12. The system of claim 11 further comprising the authentication server to:
receive a request for a public key of the recipient account, from the initiator account; and
send the public key of the recipient account to the initiator account.

13. The system of claim 11, further comprising the authentication server to:
allow a transaction to be completed. based on a successful validation.

14. The system of claim 11, further comprising the authentication server to:
cancel the encrypted transaction based on a failed validation.

15. The system of claim 11. further comprising the authentication server to:
cancel the encrypted transaction due to an expiration of the validation time limit before a successful validation has occurred.

16. The system of claim 11, further comprising the authentication server to:
authorize an escrow account to release funds to the recipient account, upon a successful validation.

17. The system of claim 11, further comprising the authentication server to:
notify, at least one of the initiator account or the recipient account of a successful validation between the initiator account and the recipient account based on a successful validation of the response hash key.

18. A client device to initiate and conduct secure peer to peer payments, the client device comprising a processor and a memory storing instructions, the instructions executable by the processor to:
send, a request to an authentication server, for a public key of a recipient account or device;
receive, the public key from the authentication server;
encrypt, a transaction to generate an encrypted message, wherein the encrypted message comprises a challenge, the public key of the account or device, and transaction details;
generate, a model hash key, the model hash key comprising a model answer to the challenge, an initiator user account identifier, and a recipient user account identifier; and
transmit, the encrypted message, and the model hash key to an authentication server; and
receive, a notification from the authentication server, wherein the notification can comprise at least one of a confirmation of a successful validation or a failed validation.

19. The client device of claim 18, wherein the instructions further comprise:
cause a transfer of funds from an initiator user financial account to an escrow account, wherein the escrow account is associated or in communication with the authentication server.

20. The client device of claim 18, wherein the transaction details can comprise any of an amount of funds to be sent, amount of funds requested, type of funds to be sent, type of funds requested, currency, bank account details, peer to peer platform account details, or a transaction type.
